(19) United States
(12) Patent Application Publication
(10) Pub. No.: US 2016/0117468 A1
(43) Pub. Date: Apr. 28, 2016

(54) Displaying Predictive Modeling and Psychographic Segmentation of Population for More Efficient Delivery of Healthcare

(71) Applicants: Vipul N. Mankad, Chapel Hill, NC (US); Joydeep Ghosh, Austin, TX (US); Yasho Rao, Austin, TX (US); Nagi Rao, Austin, TX (US); Satya Maruri, Austin, TX (US)

(72) Inventors: Vipul N. Mankad, Chapel Hill, NC (US); Joydeep Ghosh, Austin, TX (US); Yasho Rao, Austin, TX (US); Nagi Rao, Austin, TX (US); Satya Maruri, Austin, TX (US)

(21) Appl. No.: 14/525,866

(22) Filed: Oct. 28, 2014

(51) Int. Cl. G06F 19/00

(52) U.S. Cl. CPC G06F 19/3437; G06F 19/324

(57) ABSTRACT

A system and method for reducing adverse healthcare events for an ailment. First, data is processed from at least one source. The data is fed to a predictive model to obtain a set of predicted patients. These patients are predicted to experience an adverse healthcare event for an ailment within a specified time frame. Thereafter, a message is delivered to the predicted patients. The message relates to preventing future adheres healthcare events for an ailment.

### PRIORITY

This applications claims priority to Application No. 61/943,774 filed Feb. 24, 2014, the entirety of which is hereby incorporated by reference.

### BACKGROUND OF THE INVENTION

1. Technical Field

The present invention relates to a system and method for displaying predictive and psychographic segmentation of a population for more efficient delivery of healthcare.

2. Description of Related Art

Currently, a disproportionate increase in healthcare expenditure is a worldwide concern, but particularly in USA. By any measure, per capita spending or share of gross domestic product (GDP), the U.S. spending on health care is greater than all other developed countries. In 2006, the United States spent $2.1 trillion, or 16 percent of GDP, on health care, translating to $7,026 per person annually. The health care costs are growing at a much faster rate than workers' earnings. According to data from the Kaiser Family Foundation-Health Research and Educational Trust Annual Employer Survey and the U.S. Department of Labor, premiums for employment-based private insurance increased 114 percent from 1999 to 2007, while earnings increased 27 percent, leaving a gap of 7 percentage points per year, on average. Increasing healthcare expenditure is also a major concern for federal budget. Similar issues exist in developed as well as emerging economies of the world.

Excessive hospitalizations and re-hospitalizations resulting from fragmented, uncoordinated care are thought to contribute a large portion of healthcare expenditure especially in senior population covered by Medicare. Since resources such as physician or staff time to improve ambulatory care and coordination across multiple locations are always limited, focusing those resources on high-risk patients, e.g. those likely to be admitted to hospitals or generate excessive costs through adverse events, would be desirable. The standard approach has been to list patients with multiple chronic illnesses. However, such an approach has limited usefulness. Two-thirds of seniors (over 65 years of age) have multiple chronic illnesses and therefore, such lists do not allow significant focusing of resources. Additional efforts to focus resources on a smaller population predicted to generate high costs are recommended. Consequently there is a need to better predict which individuals within a population have the highest risk of hospitalizations or other adverse healthcare events.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart of the predictive and psychographic analysis system in one embodiment;

FIG. 2 is an overview of the data processing and receiving step in one embodiment;

FIG. 3 is a flow-chart showing algorithmic steps in one embodiment;

FIG. 4 is a schematic of the predictive modeling engine in one embodiment;

FIG. 5 shows results of predictive modeling for congestive heart failure admissions in one embodiment;

FIG. 6 shows the results of predictive modeling for pneumonia admissions in one embodiment;

FIG. 7 shows application of psychographic overlay to segment a population of diabetes patients in one embodiment;

FIG. 8 is a flow chart of a segmentation of a population in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

The invention, in one embodiment, relates to computerized methods to collect and analyze data, operate computer systems, perform advanced analytics and deploy results to decision makers, providers and patients for the purpose of reducing healthcare expenditure and improving quality. This is accomplished by predicting which individuals within a population have the highest risk of a future adverse healthcare event, such as a hospitalization, and/or segmenting population of those individuals into clusters matched to their responsiveness to various ambulatory care approaches. Specifically, the disclosure, in one embodiment, includes (a) computerized methods to integrate data from disparate sources such as HL7, Non-HL7, CCLF, and paper records (through OCR) into an analyzable database on a server; (b) embedding the server with advanced analytic techniques which can be used on insurance claims data alone or in combination with clinical and electronic data, to characterize the simultaneous interaction/interdependence of a large number of factors to identify individuals with high risk of hospitalizations; (c) using computerized techniques of psychographic overlay, which produces segmentation of a population into clusters of individuals likely to benefit from one or more of a variety of ambulatory care approaches such as self-help programs, phone call reinforcements or more intensive approach such as home visits. The results, displayed on computer systems, are unexpected and not obtainable through usual clinical assessment or descriptive statistical analysis or the use of “one-size fits all” clinical care approaches to manage high-risk patients.

As noted, the system and methods disclosed herein, in one embodiment, are used to reduce healthcare expenditure and specifically future adverse healthcare events. Adverse healthcare events includes hospitalizations, emergency room visits, admission into acute care inpatient hospitals, and admission into post-acute care hospitals such as skilled nursing facilities (SNF), inpatient rehabilitation facility (IRF), home health agency (HHA), hospice care, progression in the disease severity as measured by clinical symptoms and signs, staging, laboratory and imaging parameters and intensity of treatment, etc. Specifically, in one embodiment, the system and method reduce admissions or readmissions to acute care inpatient hospitals, for an ailment by providing and focusing on ambulatory care. The ambulatory care, i.e. care provided to an individual not confined to a hospital bed but in an ambulatory setting, can include physician office visits, coordination and management of the treatment plan via telephone, internet, self-monitoring or use of other communication systems. Other than an acute care hospital admission or readmission, the healthcare system may utilize admissions or readmissions to post-acute care hospitals as discussed above. The term post-acute care is used to describe such care because such care is often prescribed after an acute care admission. However, it is possible for a patient to enter such care (HHA, IRF or SNF) without being admitted to an acute care hospital. While admissions or readmissions to acute care hospitals are most expensive, per diem expenses in post acute care settings vary; IRF, SNF and HHA in decreasing order of per diem expenses, respectively.

An ailment, as used herein, refers to any disease or condition for which health care, in either an ambulatory, acute inpatient or postacute setting, can be provided. An ailment includes, but is not limited to, chronic medical conditions such as diabetes and its complications; heart diseases such as congestive heart failure, angina, and acute myocardial infarction; stroke and other cerebrovascular conditions; pulmonary conditions such as Chronic Obstructive Pulmonary Disease (COPD), and asthma; high blood pressure; memory and mental health disorders such as dementia (Alzheimer's or other types of dementia), depression, bipolar disorders and schizophrenia; cancers; arthritis and practically diseases of any organ system. The ailments also include acute medical conditions such as pneumonia, urinary tract infection, dehydration, or various conditions requiring surgery such as joint replacement and other orthopedic conditions, appendectomy, coronary bypass, etc.

In one embodiment, the predictive model predicts which patients will experience a future adverse healthcare event relating to an ailment, such as being admitted to an acute care hospital for future treatment of an ailment. In one embodiment, the predictive model is focused on future adverse healthcare events, such as hospital admission, which are considered preventable. For example, in one embodiment, the predictive model may analyze data for future occurrence of a clinical event resulting in hospitalization to an acute care hospital inpatient facility defined as a Prevention Quality Indicator (“PQI”) by the Agency for Healthcare Research and Quality (“AHRQ”). In such embodiments, the model predicts which patients will have a PQI-qualifying visit during a specified time period in to the future. This time period can vary based on the application as well as the ailment. In one embodiment the time period is one month, six months, one year, etc. Virtually any time period can be utilized.

In addition to predicting a PQI visit, such as an admission, the model, in some embodiments, can predict the type of PQI involved in the visit. For example, in some embodiments the model can predict if the PQI will involve a chronic PQI, such as all preventable admissions from chronic ailments combined, or an acute PQI, such as all preventable admissions from acute ailments combined. Further, in some embodiments, the model can predict the type of chronic or acute PQI. As an example, in one embodiment the model can predict a congestive heart failure, which is a type of chronic PQI, or pneumonia, which is a specific acute condition. One advantage of predicting all preventable acute or chronic conditions is that such a prediction is comprehensive and will affect larger number of individuals in a population. By focusing ambulatory care to a comprehensive list of patients likely to experience a future adverse healthcare event, such as a hospital admission, the health care providers can implement general care approaches such as more frequent office visits to prevent future hospitalizations. However, such an approach requires development of large number of care protocols for conditions included in the comprehensive list of acute or chronic conditions. One advantage of prediction of a specific acute or chronic ailment is that more specific disease-oriented care approaches appropriate for that illness can be designed and implemented. For example, prediction of admissions from Congestive Heart Failure allows focusing care coordination effort on those patients most likely to be admitted for Congestive Heart Failure. The Care Coordinator may call the patient frequently to ensure compliance with the medication plan (e.g. drugs called beta blockers which is a standard treatment for Congestive Heart Failure), assess sudden weight gain from fluid accumulation (which is a sign of worsening heart failure) and evaluate symptoms related to worsening of the condition. If the coordinator detects red flags, such as, for example, the patient not taking the medicine, symptoms worsening and patient gaining excessive weight over a short time, an early outpatient visit is scheduled to reevaluate the plan. In this way, an expensive admission to an acute inpatient care facility may be prevented. Similarly, prediction of an event such as pneumonia may allow focusing of efforts such as immunization, for flu or the pneumococcal vaccine, early institution of antibiotic therapy and other measures. In addition to cost savings, quality of life of an individual for whom hospitalization is avoided is also improved. The model will be described in more detail below.

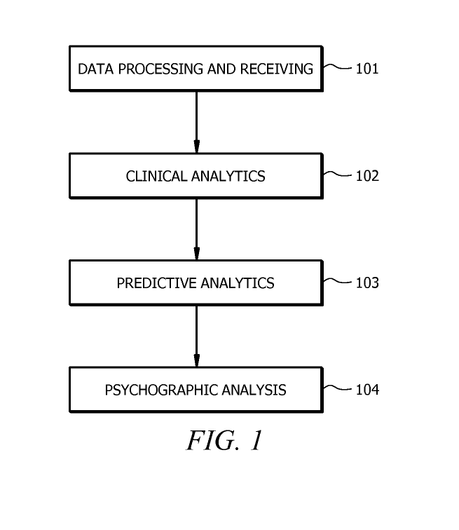

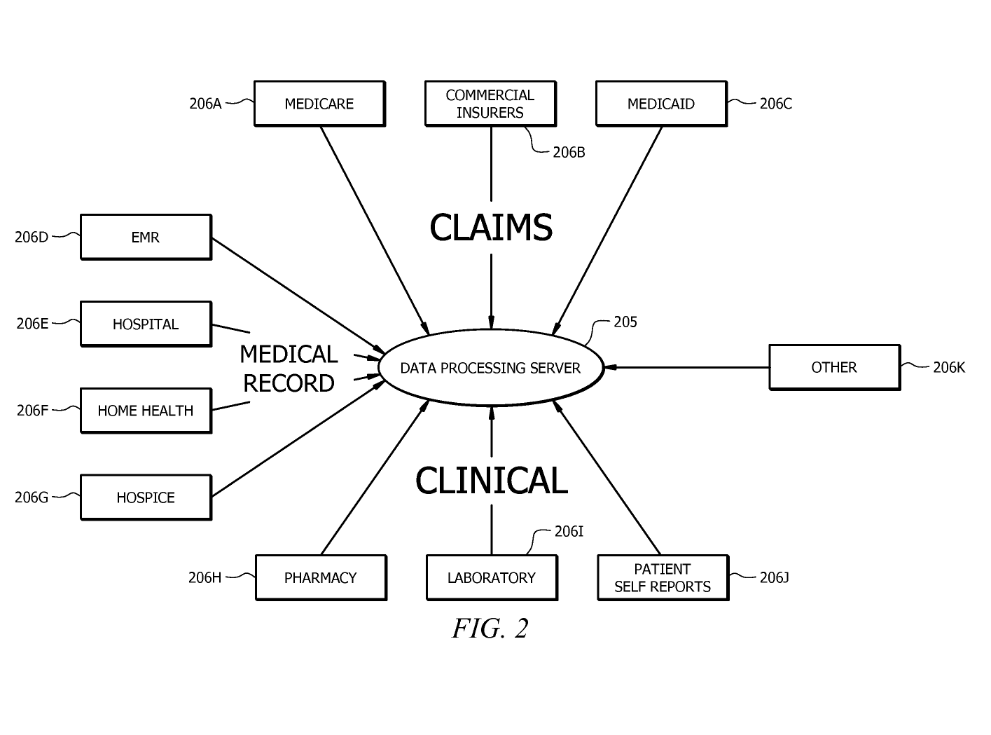

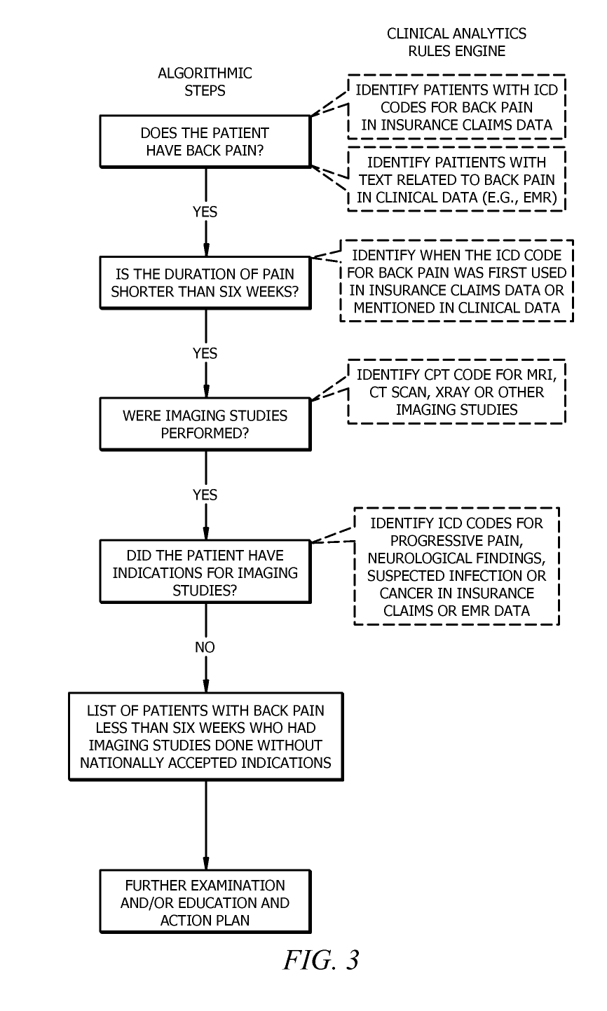

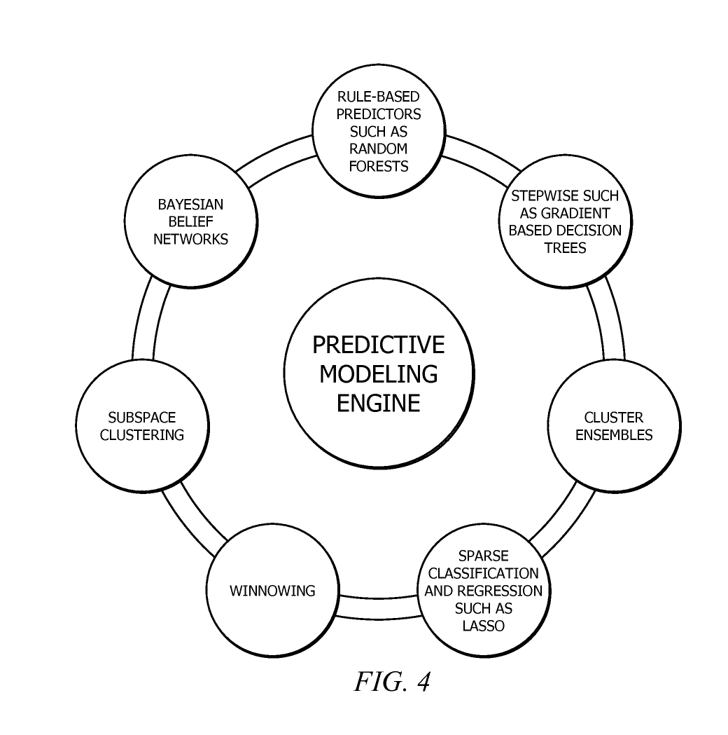

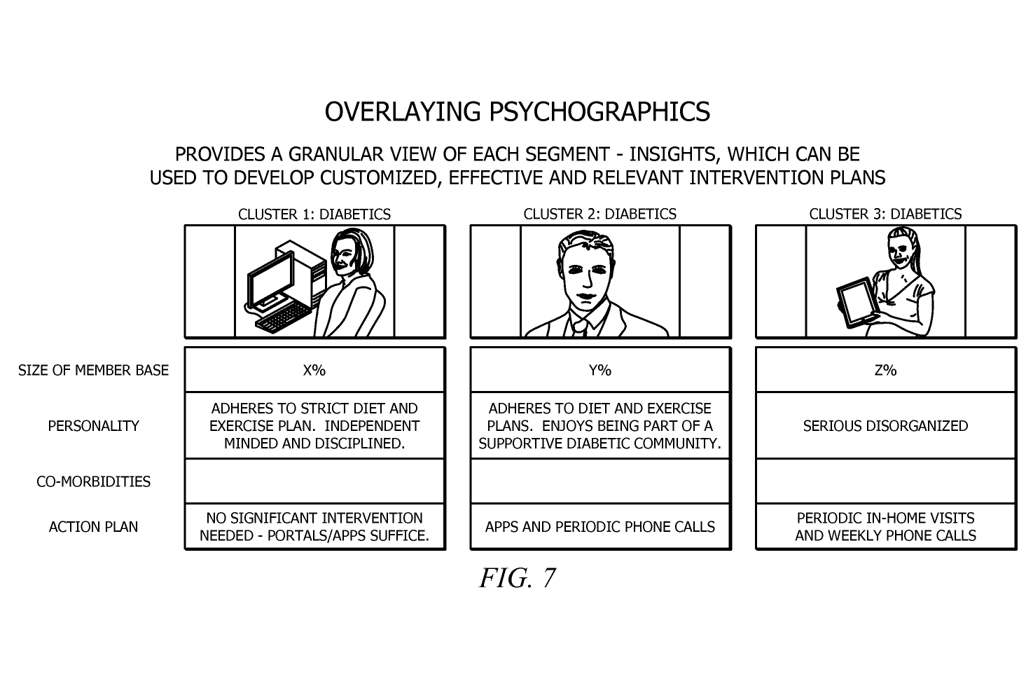

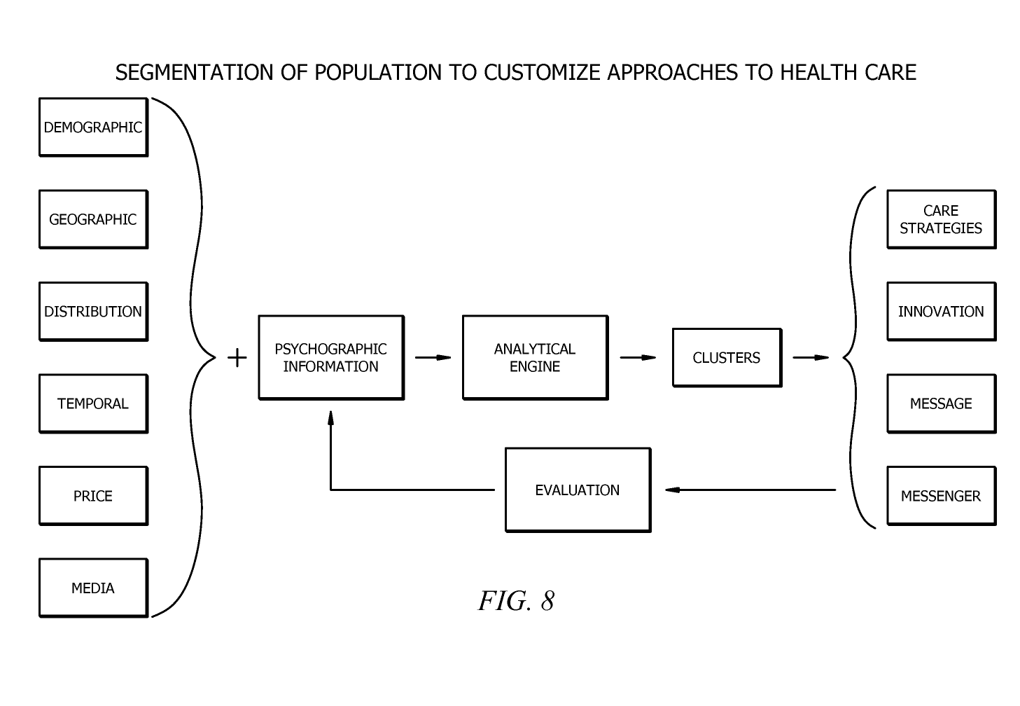

FIG. 1 is a flow chart of the predictive and psychographic analysis system in one embodiment. The first step, in one embodiment, is the data processing and receiving step 101. This is discussed in more detail in FIG. 2. During the data processing and receiving step 101, as will be discussed in more detail, data from at least one source, and in some embodiments at least two separate sources, are received and compiled. Thereafter, the second step, in one embodiment, is applying clinical analytics 102 which is discussed in more detail below. The third step, in one embodiment, is applying predictive analytics 103. This step is discussed in more detail with respect to FIGS. 3-4, below. Finally, in one embodiment, the fourth step is applying a psychographic analysis 104. This is addressed in more detail with respect to FIGS. 7 and 8, below. Clinical analytics 102, predictive analytics 103, and/or psychographic analytics 104 are not prerequisites for each other and may be carried out independently as needed.

Turning to FIG. 2, FIG. 2 is an overview of the data processing and receiving step in one embodiment. Data is collected during the data processing and receiving step 101 in order to obtain a model which can be used to predict which patients will need future treatment for an ailment. In one embodiment, and as depicted, data from at least two separate sources 206 are aggregated in a server 205. In one embodiment the sources 206 are disparate sources such as insurance claims information, electronic medical records from physician offices and hospitals, pharmacies and other providers, paper records through OCR technology, and other sources as discussed below. The server 205 can be located adjacent to or remote from the at least two separate sources 206. The server 205 can comprise a single server 205 or a plurality of coupled servers 205. The server 205 can comprise a computer, a hard drive, cloud storage, or virtually any device used for data storage.

In one embodiment, the data received from the sources 206 is, cleaned and scrubbed to avoid duplications and errors and analyzed. The scrubbing and cleaning can take place at the source 206, in the transmission from the source 206, or at the server 205. In one embodiment, the data is checked to ensure that the data relates to the managed population. Put differently, the data must relate to the managed population or it is not entered. Further, in one embodiment, the data is de-identified to remove patient names and confidential information. Further, in another embodiment the data is checked to determine if the record comprised a valid and proper code.

The data can be transmitted from the source 206 to the server 205 via any method or device known in the art. Thus, the data can be transmitted via wired and wireless methods. In one embodiment, the data is encrypted as it is being transmitted to the server 205.

In one embodiment, the data is pulled from the source 206. For example, in one embodiment, the server 205 seeks and requests information from the source 206. In one such embodiment, the data is pulled on an as needed basis. In other embodiments, however, the data is pushed from the source 206. In one embodiment, for example, data is automatically transmitted from the source 206 to the server 205. The data can be sent continuously or at a scheduled time, daily, weekly, or at a user's request.

The source 206, as used herein, refers to any source of relevant data. Examples of sources 206 include but are not limited to claims sources, medical sources, and clinical sources. Examples of claims sources include any source related to insurance claims, including but not limited to, Medicare, Medicaid, other governmental insurers, such as the Veterans Heath Administration or military, commercial insurance companies, self-insured employers managing claims through third party administrators, etc. Claims data may be “paid claims data” provided by an insurance company or “claims made” by the provider obtained through their own system such as through practice management system, hospital billing system, etc. Medical sources can include any sources related to a medical history, including but not limited to physicians, hospitals, home health, hospice, Electronic Medical Records, etc. Clinical sources includes any source of clinical data and can include but is not limited to pharmacies, laboratories, skilled nursing facilities, inpatient or outpatient rehabilitation facilities, physical and occupational therapy facilities or programs, sleep study centers, radiology and imaging centers, patent self reports, etc. Data sources may also include alcohol and drug abuse treatment facilities or other mental health or psychiatric, psychological or behavioral treatment facilities. Those skilled in the art will understand that some sources may overlap. For example, hospital records can be characterized as both a medical source, a clinical source, demographic data source or administrative data source. Other sources 206 include Centers for Medicare and Medicaid Services (CMS), hospitals, commercial or government insurance companies, public databases, and HIE. Data may also be entered by the patient and/or family, e.g. providing family history, responses to survey questions, self-monitoring of blood pressure, blood sugar or pulmonary functions. Data may also include those generated by devices with specialized sensors and automatically sent by the monitoring equipment to the database. For example, sensors may send patient's weight, blood pressure, blood sugar, whether the pill box was opened at a particular time, etc.

As depicted, in one embodiment, the source 206 comprises at least two difference sources 206. As depicted, the system in FIG. 2 depicts a pharmacy 206H and insurance claims 206B. Having two or more sources 206 provides more accurate data, resulting in a better prediction. For example, referring to the pharmacy 206H, a pharmacy 206H provides several advantages. First, it provides data relevant to a patient such as which prescriptions the patient has filled. This data can be used in the predictive modeling. Second, collecting data from a pharmacy provides a way to cross-check other sources. As one non-limiting example, in one embodiment a physician will write a prescription to a patient. The physician, in one embodiment, is a source 206 and the issued prescription will be transmitted to the server 205. However, knowing only that a prescription was issued does not demonstrate if the prescription was filled. Put differently, obtaining data only from a single source, such as the physician, may only tell part of the story. By obtaining, in one embodiment, data from the pharmacy, for example, it can be determined if the patient actually filled the issued prescription. Accordingly, obtaining data from the pharmacy provides the unexpected advantage of additional accuracy.

As depicted, in one embodiment, the source 206 comprises insurance claim data. One advantage of insurance claims data is that this data often provides a global view of healthcare of the patient. All healthcare activities, whether they occur in a specific physician's office or out-of-network physician, primary care physician or a specialist, hospital in the network or outside the network, even outside the state, are all included if the insurance company paid for services. Thus, for example, if only the data from a physician were utilized as a source 206, then this data would be limited to the services rendered by that specific physician. This would be a very limited review of the patient's overall health record. However, insurance data includes information from every physician the patient visits, every prescription the patient fills, admissions to hospital facilities within or outside the network, etc. Thus, the insurance claims data often provides a better global view of the patient's history. As depicted, in one embodiment, the source 206 comprises EMR data 206D. One advantage of EMR data is that information is real time with little or no lag. Also, some information such as patient's weight, smoking status, and many other clinical features that are not essential in generating an insurance bill are available through EMR and other sources of clinical data. Thus, this data is helpful in obtaining a more accurate predictive model. However, EMR and clinical data generally come from one specific clinician's office or from one hospital or one pharmacy. Thus, such information alone does not provide global point of view.

The data within the sources 206 can comprise virtually any form. In one embodiment the data from at least one source 206 comprises a CMS Claims and Claims Line Format (CCLF format). In other embodiments data from at least one source 206 comprises HL7 and non-HL7 electronic medical records. In still other embodiments the data comprises paper records. Such records can be converted to an electronic format via any method or device known in the art, including but not limited to Optical Character Recognition (OCR).

In one embodiment, once the data is collected in a server 205, the data is analyzed in the clinical analytics step 102 to produce refined data. In one embodiment, Clinical Analysis uses algorithms developed from clinical guidelines published by professional societies, NIH, CDC, AHRQ, and other groups. In one embodiment, algorithms use various ICD-9 codes and/or ICD-10 or subsequent versions in the future, as well as relevant text from electronic health records and analyze the database for compliance or deviation from clinical guidelines. Clinical Guidelines are based on consensus on best practices by nationally known experts and on available evidence (e.g. peer reviewed, randomized clinical trials, epidemiological data, comparative effectiveness studies, or case reports). Therefore, adherence to clinical guidelines with appropriate consideration of the individual circumstance of the patient, is most likely to result in desirable outcomes.

In one embodiment, guidelines for “don't do” are utilized for data analysis. FIG. 3 is a flow-chart showing algorithmic steps in one embodiment. The boxes on the left of FIG. 3 outline an algorithmic step in one embodiment which results in a yes or no answer. To the right of each box is a Clinical Analytics Rules Engine which illustrates how the software accomplishes the algorithmic step. The end result, in this embodiment, is a list of patients is generated where the patients experienced back pain in the last six weeks and who underwent imaging studies without an indication. In other embodiments the opposite can be true. As an example, the software can examine the documentation supports and the presence or absence of indications for imaging. Thus, if a physician orders an imaging test but has not documented an indication, the software can alert the physician to ensure the physician is aware that guidelines are perhaps not being followed. This is only an illustrative example and should not be deemed limiting.

Referring to FIG. 3, in one embodiment, a list of patients with low back pain who receive expensive imaging tests such as MRI or CT scan of the spine is gathered. As shown in the figure, the Clinical Analytics Rules Engine looks for one of many ICD9 codes for diagnosis of low back pain. Such patients can be identified through ICD9 codes recorded in insurance claims data, EMR from a physician or a hospital, or other sources. Subsequently, using CPT codes for procedures, those receiving MRI, CT Scan or X-rays within six weeks of the onset of low back pain are identified. Subsequent steps determine if there were indications for performing MRI or CT scan such as progressive, severe pain, neurological signs suggestive of impending neurological damage, infection such as osteomyeltis, tumors of the spine or nervous system, etc. determined by ICD9 codes in the insurance claims or information from EMR. Since most episodes of low back pain are self resolving, if the above indications are not present, an imaging test is considered potentially unnecessary. The records of patients listed as having potentially unnecessary imaging study are then further examined to confirm unnecessary testing. The analysis may reveal excessive use of imaging in low back pain emanating from a specific provider, for a specific group of patients or in a specific institution. Counseling of providers, institutional leadership or patients can reduce future unnecessary imaging, reduce costs and improve quality (e.g. avoid unnecessary radiation to the patient). Other embodiments of “don't do” type analysis include use of brand name statins when a generic statin would suffice, routine use of cardiac screening without indications in a healthy adult, urinalysis in a healthy adult, use of antibiotics in sinusitis, etc. In yet other embodiments, clinical analysis can undertake what should be done (in contrast to “don't do” list). For example, diabetes patients should receive evaluation of their long term blood sugar control through a test called HgbA1c, receive advice to quit smoking, have periodical retinal and foot examination, among other activities. Clinical analysis determines the proportion of patients who receive recommended care and targets providers and patients who should receive education. Results of the clinical analysis may be utilized retrospectively, e.g for education and quality improvement or prospectively by alerting the physician about activities that should be performed or avoided for patients scheduled on a particular day.

In addition to the clinical analytics step 102 and independent of that step is the predictive analytics step 103. Refined data is fed into the predictive model. FIG. 4 is a schematic of the predictive modeling engine in one embodiment. FIG. 4 depicts many of the various methods which can be used in the predictive model. The Predictive Analytical Methods can use virtually any analytical method known in the art. These models include, but are not limited to, sparse (regularized) classification and regression techniques, winnowing, subspace clustering, cluster ensembles, stepwise such as gradient based decision trees, and Bayesian Belief Networks that exploit conditional independence and sparse covariance estimation to manage a large number of predictors and other variables, and combinations thereof. In one embodiment the model uses one method whereas in other embodiments the model uses two or more predictive methods in the analysis step 103. The number and type of methods used will be dependent, in part, upon the specific ailment and the end point being predicted.

As noted above, a small number of patients are responsible for a large proportion of the healthcare costs. In fact, estimates show that 5% of patients are responsible for about 43-47% of healthcare costs. However, the same 5% do not necessarily cause high expenditure year to year since some patients die and in others, the problem may be resolved. For example, a specific patient with massive heart attack may die but may generate significant costs in the final days. Another patient with a heart attack may receive a coronary bypass surgery, which also has high costs. Neither of these patients will generate high costs in the subsequent year. One key to cost reduction is to predict patients who have high probability of generating costs in the future. Accordingly, in one embodiment, the model discussed herein, predicts which patients will be the 5% responsible for a large share of the costs in the future. A set of predicted patients is the list of patients selected from a group which are predicted to require greater amount of ambulatory care in the future to prevent an adverse, more expensive event such as admission to an acute care hospital within a specified time frame. As noted above, the specified time frame can be virtually any time frame and includes one month, six months, one year, etc. Proper care and resources can be directed to these predicted patients to decrease the number of hospital admissions, thus reducing overall healthcare costs, and saving money. To illustrate the predictive model, a few illustrative examples, empirically tested and validated, are provided. These examples are for illustrative purposes only and should not be deemed limiting. In one embodiment, to develop a predictive model for Congestive Heart Failure Admissions to acute care hospitals, a vector of 325 features was generated. In this embodiment, the features were selected from a much larger number of potential features through a sequence of steps that progressively eliminated the most redundant features. These steps considered quality of the feature data (e.g. percentage of missing values), correlation with target values, correlations with other features, factor analysis and finally feature elimination during model fitting using LASSO, a regularization based procedure. These vectors included: (a) demographics: sex, race and age at a particular time; (b) population level data derived from normalized fraction of population that graduated high school and normalized median income in the patient's ZTCA (Zip Code Tabulation Area) as defined by the US Census Bureau; (c) healthcare utilization: count of outpatient, inpatient, SNF, HHA and Hospice visits in the past month and past 12 months; (d) flags indicating whether a patient received diagnosis in each of the “second level” ICD-9 groups in the past month and past 12 months; and (e) updated codes for chronic conditions as additional flags. For healthcare utilization and ICD-9 flags, the past 12 month period is inclusive of the past 1 month period. In another embodiment, the set of features included time periods for the healthcare utilization and diagnosis group flags which did not overlap (i.e. usage and flags for past 0-1, 1-6 and 6-12 months). A person with ordinary skill in the art can apply these techniques using various combinations of features mentioned above and new features that become available. For example, ICD-9 codes will be revised in the ICD-10 versions with larger number of diagnoses and subsets of diagnoses. However, the technique can be applied to features in ICD-10 version or future versions and will potentially improve predictive ability.

The ability to analyze multiple features in a system, such as a system comprising a server, is an advantage. The system can balance many features, such as 10 or more features, or the 325 features described above, to account for features from data sources. The ability to account for, and utilize, a plurality of features allows for a more accurate model. Further, the use of such a large number of features in the human mind was previously difficult, if not impossible. The use of a system allows the processing of a much larger quantity of features, leading to a more accurate model.

The above features were extracted from data on 4,267 patients based on CMS claims information alone from Jan. 1 through Dec. 31, 2012. Inpatient claims information from Jan. 1 through Jun. 1, 2013 were then extracted and identified those visits that met PQI criteria as defined by AHRQ. The PQI visits (hospital inpatient admission as defined in the AHRQ PQI standards) were aggregated to a per-patient level to form a set of predictive targets. The models were developed to predict those patients who would have a PQI qualifying visit between Jan. 1 and Jun. 1, 2013. The model was evaluated using the area under the curve (AUC) of the model's Receiving Operating Characteristics (ROC) and the lift for the model at 1%, 5% and 10% of the cases labeled.

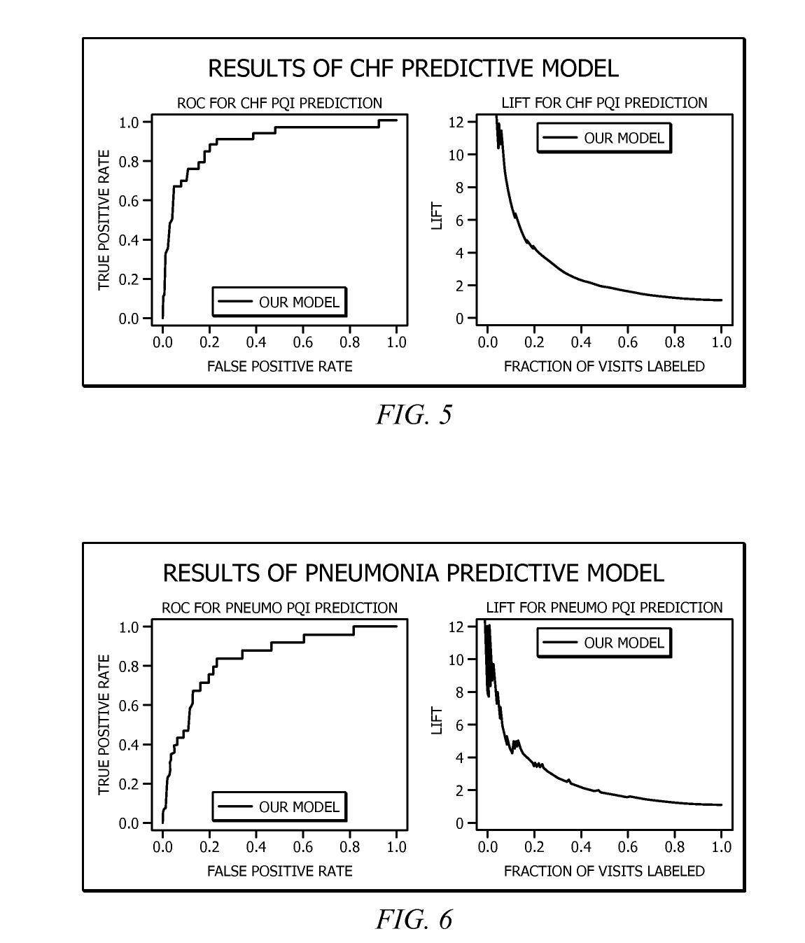

FIG. 5 shows results of predictive modeling for congestive heart failure (“CHF”) admissions in one embodiment. The predictive modeling was performed on CMS Medicare Claims data alone from a population of 4,267 patients over 65 years of age. Accordingly, the figure is not a hypothetical model on fictitious data but results of an experiment conducted in a specific population using real data. Typically, in a Receiver Operating Characteristics (ROC) study, area under the curve (AUC) of greater than 70% is considered significant. In the model depicted, the AUC was 89.3%. The results demonstrate that 89.3% of true positives can be detected while accepting only about 10% of false positives. As noted, the model utilized 325 features to predict the patients which would require admissions. Table 1, below, lists the top features ranked in descending order of their weights are listed in Table 1, below.

TABLE 1
Top Features for CHF PQI

| Feature | Weight |
|---|---|
| ICD9 690-698: other inflammatory conditions of skin and | 2.2061 |
| subcutaneous tissue (0 to 1 m) | |
| ICD9 E916-E928: other accidents (0 to 1 m) | 1.2588 |
| ICD9 420-429: other forms of heart disease | 0.9158 |
| (0 to 1 m) | |
| ICD9 287-287: purpura and other hemorrhagic conditions | 0.8384 |
| (0 to 12 m) | |
| ICD9 440-449: diseases of arteries, arterioles, and capillaries | 0.8366 |
| (0 to 1 m) | |
| ICD9 550-553: hernia of abdominal cavity (0 to 12 m) | 0.8350 |
| ICD9 420-429: other forms of heart disease (0 to 12 m) | 0.7908 |
| ICD9 680-686: infections of skin and subcutaneous tissue (0 to | 0.7460 |
| 1 m) | |
| ICD9 V10-V19: persons with potential health hazards related | −0.6779 |
| to personal and family history (0 to 1 m) | |

The graph on the right side of FIG. 5 shows a lift of 17.6 at 1% compared to random or no model operation. Thus, the model for CHF is surprisingly powerful. These astonishing results were obtained by using CMS claims data (along with other publicly available data sets as described above) but without the use of EMR or other types of clinical data. If EMR or other types of clinical data were integrated, such as physiologic data such as systolic ejection fraction from an echocardiograph-a precise indicator of the severity of heart failure or NYHA Score for Severity of CHF, the AUC and the Lift may even be greater than with CMS claims data alone. However, such improved precision may not be essential. The advantages of using CMS insurance claims data and other publicly available data are that (a) such data are now readily available, and (b) analyses provide powerful tools to leaders of healthcare organizations (e.g. CEO, CMO or Medical Director) to make management decisions and (c) results can be deployed to clinicians as they see patients (or prior to patient visit). EMR data are often incomplete. However, incompleteness of EMR data does not influence the claims-based model presented here. On the other hand, advantages of integrating EMR and other clinical data are (a) additional specificity and power achieved by integrating clinical information and (b) timeliness of capturing recent health events without the lag inherent in the insurance claims data. The model described here captures best of the both worlds and yet, functions on insurance claims data without requiring clinical data from EMR; however, it should not be interpreted as limiting.

FIG. 6 shows the results of predictive modeling for pneumonia admissions in one embodiment. The predictive modeling for pneumonia was performed on the same population as addressed in FIG. 5.

The top ten features rank ordered for their weights in the current predictive model for pneumonia are listed in Table 2, below.

TABLE 2
Top Features for Pneumonia

| Feature | Weight |
|---|---|
| HHA visit in in last 0 to 1 m | 1.5316 |
| ICD9 150-159: malignant neoplasm of digestive organs and | 1.0072 |
| peritoneum (0 to 1 m) | |
| ICD9 260-269: nutritional deficiencies (0 to 1 m) | 0.8189 |
| ICD9 190-199: malignant neoplasm of other and unspecified | 0.7833 |
| sites (0 to 12 m) | |
| ICD9 451-459: diseases of veins and lymphatics, and other | 0.6659 |
| diseases of circulatory system (0 to 1 m) | |
| ICD9 288-288: diseases of white blood cells (0 to 1 m) | 0.5148 |
| ICD9 170-176: malignant neoplasm of bone, connective tissue, | 0.5097 |
| skin, and breast (0 to 1 m) | |
| ICD9 870-897: open wounds (0 to 12 m) | 0.4970 |
| ICD9 287-287: purpura and other hemorrhagic conditions | 0.4877 |
| (0 to 1 m) | |
| ICD9 480-488: pneumonia and influenza (0 to 12 m) | 0.3887 |

In FIG. 5, the AUC is 83.9% with a lift of 8 at 1%. Thus, this model demonstrates that future pneumonia admissions can be predicted and prevented accordingly.

Table 3, below, shows the numerical data from the above experiment. All four predictive models exceed criteria for performance on ROC, suggesting that the model is applicable to many conditions and is generalizable.

TABLE 3
Numerical data

| Model | AUC % | Lift at 1% | Lift at 5% | Lift at 10% |
|---|---|---|---|---|
| CHF | 89.3 | 17.6 | 11.8 | 7.0 |
| Pneumonia | 83.9 | 8 | 8 | 4.8 |
| Chronic | 83.6 | 18.5 | 6.6 | 5.6 |
| Conditions | | | | |
| combined | | | | |
| Acute | 79.5 | Not available | 5 | 4.2 |
| Conditions | | | | |
| Combined | | | | |

While FIGS. 5 and 6 were related to CHF and pneumonia, the predictive model is not so limited. Additional embodiments can include predicting patients who may be admitted for COPD, asthma, diabetes, high blood pressure, angina and virtually any other ailment where improved ambulatory care prevents hospitalizations or other adverse events. The predictive models may also be developed to predict events requiring post acute care. Thus, in addition to reducing admissions to acute inpatient units, utilization of more expensive post acute care such as in IRF or SNF allows design of less expensive care such as HHA. Each of these predictions, e.g. admission for congestive heart failure or pneumonia or any other ailment, relates to healthcare costs. In addition, predictive model can be developed to identify individuals who are likely to generate overall healthcare costs regardless of the acute or chronic disease condition. To segment the population into clusters with varying responsiveness to ambulatory care and care coordination approaches, in one embodiment psychographic methods derived from information contained in the electronic health records or obtained through natural language technology or specially designed surveys are utilized.

Turning back to FIG. 1, in one embodiment, after the predictive analytics step 103 is the psychographic analysis 104. This approach allows the healthcare organization to focus its resources for psychographic analysis on patients predicted to have high risk of admissions to acute care hospitals or suffer from adverse events. However, psychographic analysis 104 may be performed on the entire population under management. Thus, the predictive modeling step 103 should not be interpreted as a pre-requisite for performing psychographic analysis 104. In the embodiment shown in FIG. 1, once it is predicted which patients are likely to be admitted or otherwise require treatment for a given ailment, then different approaches (i.e. care plans) can be implemented with those patients to decrease or eliminate the need for the predicted acute inpatient hospital care. However, patients do not respond to care plans in the same way; thus, one size does not fit all. In one embodiment, to segment the population into clusters with varying responsiveness to ambulatory care and care coordination approaches, psychographic analysis is performed on data derived from information contained in the electronic health records or obtained through natural language technology or specially designed surveys.

FIG. 7 shows application of psychographic overlay to segment a population of diabetes patients in one embodiment. While FIG. 7 demonstrates a psychographic overlay with respect to diabetes, this is for illustrative purposes only and should not be deemed limiting. Three individuals with diabetes are depicted who share demographic similarities in age, race and sex. These seemingly similar individuals, at least at the demographic and clinical level, can be segmented into several personality types: for example, a highly motivated compulsive individual, a socially engaging individual, and a disorganized individual. A highly motivated, compulsive individual is more suited to self-help approaches and does not likely require or prefer phone calls, reminders, etc. After applying the psychographic analysis, it may be determined that this class of individual does not require the same level of care coordination resources or attention that other groups may require. Frequent calls to such individuals may even cause irritation or interruption in care. This group may respond better to self-help apps which allow the individual to pursue healthcare goals on their own time, self-assessment tools, gaming and reward systems that recognize individual effort. In the second group, a person with a socially engaging, somewhat laid back personality may appreciate and need telephone reminders from a care coordinator. In addition to telephone conversations with a Care Coordinator, individuals in this group may benefit from virtual or face-to-face disease management groups. Finally, for a seriously disorganized individual, telephone reminders or self-help apps are not sufficient. He/she may need a home visit to help in organization or perhaps a nutritionist accompanying them to the grocery store to teach selection of foods. Thus, the preventative care can be customized to fit an individual's needs. This allows resources and care to be more effectively allocated to achieve a maximum impact of ambulatory care and reduction in acute inpatient care.

The dictum of “one size does not fit all” is well known to physicians and other providers who make decisions to recommend specific care to individuals. However, decisions to individualize care plans are often made on the basis of somewhat limited data available to the physicians or other providers and depends on the heuristic approach of the clinician. Also, these decisions are not made at a population level based on psychographic segmentation. For example, a provider will depend on clinical diagnoses and co-morbidities, simple heuristic such as age, sex, race and perceived or known socioeconomic background, and “gut level” impressions of care and follow up approach that might be effective in a given patient. Extensive as this may appear to the provider, data about patient's personality, attitudes and preferences are not available to the provider. To date, healthcare systems have not employed systematic psychographic studies to segment the population into groups based on attitudes and personalities to deploy patient care approaches likely to be more effective and cost efficient. More recent phenomenon of consolidation and organization of practice of medicine and increased availability of electronic databases presents an opportunity previously not observed in healthcare industry. The goal of the psychographic analysis, in one embodiment, is to segment the population of patients into clusters which share certain personality characteristics and attributes and match those clusters with patient care approaches likely to be effective (i.e. achieve desired clinical goals) and cost efficient (i.e. achieve goals with optimum use of resources).

The purpose of the segmentation, in one embodiment, is to concentrate efforts and resources to gain marketing advantage. In case of healthcare, the strategy, in one embodiment, is to market the care approach to patients and their families more effectively and cost efficiently by tailoring the message and the messenger to each segment of the patient population. Thus, once armed with a predictive model of predicting which individuals may require future treatment for an ailment, segmentation allows a preventative care strategy to be customizable to fit the needs of the individual patient. The dataset is analyzed to develop information about clusters within population that share certain psychographic characteristics and have preference for specific care strategies. Such information is utilized to innovate care strategies that are more effective than standard methods including selection of messengers and messages that are likely to be effective. A message, as used herein, refers to instructions, information, a plan, strategy, etc., which aids a patient in treating an ailment and preventing a future adverse healthcare event. In one embodiment two or more different messages are available, and as noted above, depending upon the results of the segmentation, a message is chosen which will be most suitable to the patient. The message can be delivered to the patient via any delivery mechanism. A delivery mechanism is any mechanism which delivers a message to a patient, and can include, but is not limited to, a text message, an email, a phone call, a letter, a person-to-person discussion, etc.

FIG. 8 is a flow chart of a segmentation of a population in one embodiment. The flowchart shows the segmentation methods on the left with customized care approaches on the right. In the middle of the flow chart the segmentation is added to the gathered psychographic information and applied to the analytical engine, which segments the population into clusters. As depicted, the system comprises an evaluation loop wherein the system can be evaluated and improved.

FIG. 8 depicts several standard segmentation methods, including demographic, geographic, temporal, distribution, price, and media. These are discussed in more detail below.

Geographic Segmentation: A company selling chain saws would do well to concentrate its marketing in geographic areas with forests. Similarly, healthcare institutions frequently focus approaches such as anti-malarial prophylaxis to geographic areas where mosquitoes and malaria are prevalent. However, for many ubiquitous problems such as diabetes/obesity, coronary disease and heart failure, high blood pressure, asthma and COPD and others that are prevalent in nearly all regions, geographic segmentation approach has limited usefulness.

Distribution Segmentation: Public health approaches to diabetes or high blood pressure are often concentrated in populations where such conditions are more common, e.g. diabetes education in Pima Indians or blood pressure screening in African Americans. Innovative methods of delivering the message include community-based approaches to control high blood pressure in African Americans, for example. Once again, for problems common to all populations, such approaches have limited usefulness.

Demographic Segmentation: As stated above, clinical care approaches are often tailored to age, sex, race and other demographic features of the population. For example, one would do well to focus breast cancer screening in women or prostate cancer screening in men. However, many conditions cross over into multiple segments created by demographic segmentation.

Temporal Segmentation: Campaign for flu vaccine from fall to spring is an example of tailoring care approach to seasonality of illnesses.

Price Segmentation: High concentration of discretionary health care such as cosmetic surgery in Beverly Hills or other affluent areas is an example of price segmentation.

Media Segmentation: Certain media, e.g. TV, Radio, Internet and Web-based information, emails, and social media work on some and not on others. Healthcare institutions have generally not done very well in selecting appropriate media for various population segments due to lack of psychographic information.

The above standard segmentation methods can be used to partially segment a population based on broad categories. For example, based on age alone, it can be inferred that a younger patient will be more likely to utilize social media. Accordingly, sending messages and reminders about preventative treatment may be more effective with younger patients. However, these standard segmentation approaches, alone, have limited usefulness compared to psychographic segmentation. A standard segmentation segments a group based on broad characteristics such as age, race, geography, etc. This is contrasted with psychographic segmentation which segments a group based on individual likes, dislikes, personality traits and attitudes, etc. Thus, psychographic segmentation is based on specific and individualized responses from the individual. Psychographic segmentation sharpens the ability to deliver care in a manner that is more likely to work. Psychographic segmentation is based on the study of personality, values, attitudes, interests, and lifestyles. Because this area of research focuses on interests, attitudes, and opinions, psychographic factors are also called IAO (short for “Interests, Attitudes, Opinions”) variables or Values, Attitudes and Lifestyles (VALS). Psychographic studies of individuals or communities can be valuable in the fields of marketing, demographics, opinion research, futuring, and social research in general. In one embodiment, psychographic segmentation provides a tool to discover customers whose behavior can be changed or whose needs are not being met.

The analytical engine shown in FIG. 8 performs cluster analysis. The purpose of cluster analysis is to place individuals into groups, or clusters, suggested by the data, such as responses to survey questions and all other available data, rather than placing the individuals into groups defined a priori. Individuals in a given cluster tend to be similar to each other in some sense, and individuals in different clusters tend to be dissimilar. Often entitled, “k-means clustering”, a person skilled in the art of clustering will be able to use the method, which aims to partition n observations into k clusters in which each observation belongs to the cluster with the nearest mean, serving as a prototype of the cluster. Although psychographic segmentation methods have not been applied in healthcare, a person with skills in the art can apply from vast variety of clustering methods available from other industries. Several types of clusters are possible. Disjoint clusters place each individual in one and only one cluster (e.g. (i) Type A highly organized personality, or (ii) socially engaging laid back personality or (iii) disorganized personality). Hierarchical clusters are organized so that one cluster can be entirely contained within another cluster but no other kind of overlap between clusters is allowed. For example, individuals with memory disorders (who are likely to have difficulties in following prescribed treatment plan) may be found within each disjointed cluster. Overlapping clusters can be constrained to limit the number of individuals who belong simultaneously to more than one cluster or they can be uncontrainted, allowing any degree of overlap in cluster membership. Fuzzy clusters are defined by a probability or grade of membership of each object in each cluster and can be disjoint, hierarchical or overlapping. In one embodiment, turf analysis determines the best combinations of overlapping clusters. For example, does a combination of Clusters A+B provide maximum impact of a treatment strategy or a combination of Clusters A+C? The Turf Analysis determines the strategies appropriate for overlapping clusters.

As noted, one type of psychographic segmentation includes lifestyle. Different people have different lifestyle patterns and their behavior may change as they pass through different stages of life. As an example, a family with young children is likely to have a different lifestyle than an older couple whose children have left home. Accordingly, these different groups will likely have significant differences in health related behavior patterns. As noted above, another type of psychographic segmentation is IAO. IAO covers a large area which includes an individual's political opinions, views on the environment, sporting and recreational activities, religion, and arts and cultural issues. The opinions that individuals hold and the activities they engage in will have a major impact on health related behavior. As an example, an individual who is an active runner or who focuses on organic food may be more likely to monitor their diet and take a hands-on approach in their health related behavior patterns. Further, an individual who regularly utilizes texting on smart phones, or applications such as Facebook® will be more susceptible to electronic reminders, applications, etc. which focus on their health.

The degree of loyalty an individual has is another type of psychographic segmentation. Continuity of specifically tailored approaches ensures continuous engagement with the healthcare system and promoting the desired health behavior pattern. An individual who will consistently engage with a specific care approach, such as self-care, continued interaction with a physician, etc., can be relied upon to finish and complete the suggested regimen. Such individuals may require fewer reminders than other individuals.

Occasions is another type of psychographic segmentation. This segmentation type segments on the basis of when a product was purchased or consumed. On example of this is that joining a health club is common after New Year's resolutions. Simply knowing that a patient has a health club membership as of January 15 may not mean as much if the patient joined the health club on January 1.

The benefits sought by the patient is another type of psychographic segmentation. As but one example, longevity is not the only benefit of healthy weight maintenance. Quality of life issues such as being able to travel or interact with grandchildren are other considerations for seniors.

In one embodiment, the system uses unique psychographic tools for application in healthcare and adapts them to computerized analysis of populations. In one embodiment, and as depicted in FIG. 8, various population segmentation methods (demographic, geographic, temporal, etc.) are added to psychographic survey information. This database is analyzed to create clusters of patients with similar psychographic characteristics. Customized and innovative care approaches are designed and tested for these clusters. The nature of the most effective message and messenger are defined. In one embodiment, the system is evaluated periodically and improved.

The process of the psychographic analysis begins with obtaining data from a group. In one embodiment the process begins with discussion in a focus group. Such discussions allows the healthcare organization to appropriately frame the questions to the larger group. The cluster analysis will determine the types and number of segments, defining the attitudes, values, beliefs, and behavior which are relevant to a specific ailment. Next, healthcare organization will determine the possible care strategies which are available. These include, for example, internet, email, home monitoring, reporting, face-to-face discussions, etc. In some embodiments, an innovative method must be developed to address the psychographic profile for a specific cluster. In some embodiments new strategies, such as an Application or sensors are developed as necessary. A customized message, message delivery system, etc. can be tailor made for each separate cluster.

As one example, consider a small Medicare ACO of 5,000 individuals. If the populations comprises of seniors, one would expect 26.9%, or 1,345 of those patients to have diabetes. If a Care Coordinator can each handle 100 patients, the population will require 14 Care Coordinators at a cost of approximately $1.12 million in staffing salary alone. Such a large expenditure may not result in desired outcome since only a portion of the population may respond to Care Coordination approaches. Segmentation and the predictive model can be used to decrease these costs, as shown below.

In one embodiment, the population is segmented based on predictive modeling for admissions. Predictive model is applied to all 5,000 patients and each individual rank ordered for probability of admissions for diabetes related complications. From the rank ordered list, a specific number, e.g. top 100 individuals, is chosen. This results in a smaller segment of 100 individuals which are identified on the basis of their rank on predictive modeling for admissions to acute care hospitals and selected for psychographic studies. The exact number, in this example, 100, can vary depending on the resources available. In one embodiment, the predictive model is applied to the entire population, with the goal of the model to select 1% to 5% of that population so that the resources are focused. When applied to diabetes, for example, the top 1% to 5% from the predictive model will have not only the diagnosis of diabetes but also other features that help predict the hospitalization.

The psychographic analysis may indicate, for example, that of the 100 patients selected, only 35 patients require Care Coordinators through a staff member whereas the remaining 65 can be managed through electronic media. Accordingly, the number of required Care Coordinators for this population can be reduced from 14 to about 0.3. The cost for Care Coordinators will be reduced from $1.12 million to about $26,666. Further, the care provided by the Care Coordinators will be more effective because the messenger and the message delivered are targeted to those who will benefit most from it.

In an additional twist, even if the psychographic segmentation is applied to each of the 1,345 patients with diabetes, if the same percentage of 35% needing Care Coordinators results, then 4.5 Care Coordinators are needed for a cost of $360,000. Accordingly, it can be seen that predictive modeling with psychographic segmentation results in considerable cost savings. However, in other embodiments, each technique can be applied independently.

As noted above, in one embodiment the psychographic data is collected via surveys or other such methods. Such methods, however, may be difficult to obtain for very large populations. Accordingly, in some embodiments, a small sample size is used for the psychographic data. The individualized care can be applied to the small sample size, and the results from the sample size can be compared to more traditional care delivery. Beginning on a small scale allows the approach, model, and or care provided to be tweaked and modified as necessary before applying it across the entire population.

Further, providers, patients, and families may have limited time to participate in the psychographic data collection. This can be addressed by being selective in the number and type of questions in the survey. Further, in some embodiments, a survey or other method for collecting psychographic data collection directly from the patient, provider, or family can be replaced and/or supplemented by utilizing natural language processing on medical records or other data obtained from a source 206. A natural language search, or other search, can extract data from the sources 206 which may be useful in conducting a psychographic analysis. As but one example, medical records may indicate that a patient had a “marathon injury.” Such a result would indicate that the patient is a runner. This data can be used in psychographic segmentation. Similarly, statements by front desk or nursing staff about “habitually late” or “did not return phone call” may indicate a more laid back or disorganized personality type. The ability to conduct a natural language search, or other such search, offers several benefits. First, it is an additional source of data which can be used in the psychographic segmentation. Second, it is data which is obtained without putting any additional burden on providers, patients, etc.

While the invention has been particularly shown and described with reference to a preferred embodiment, it will be understood by those skilled in the art that various changes in form and detail may be made therein without departing from the spirit and scope of the invention. For example, the embodiments described above address conditions which are frequently admitted to acute care hospital inpatient facility. However, other embodiments include predictive modeling and psychographic overlay to customize care plans targeting other cost centers and quality issues such as emergency room visits, reducing stay in some of the more expensive post acute care facilities (e.g. IRF, SNF, or HHA). Yet other embodiments include predictive modeling and psychographic overlay for disease progression, e.g. diabetes patients in good control developing poor control (HgbA1c less than 8% to levels greater than 9%) and then, developing complications (e.g. amputation of a limb due to diabetic gangrene) or blindness from diabetic retinopathy.

### ADDITIONAL DESCRIPTION

The following clauses are offered as further description of the disclosed invention.
Clause 1. A method of reducing adverse healthcare events for an ailment, said method comprising the steps of:
   processing and receiving data from at least one source;
   feeding said data to a predictive model to obtain a set of predicted patients, wherein the set of predicted patients are predicted to experience an adverse healthcare event for said ailment within a specified time frame;
   delivering a message to said predicted patients, wherein the message relates to preventing future adverse healthcare events for said ailment.
Clause 2. The method of any proceeding or preceding claim further comprising the step of applying clinical analysis to the data received from said at least one source.
Clause 3. The method of any proceeding or preceding claim wherein said clinical analysis step utilizes an algorithm, wherein said algorithm use various ICD-9 and/or ICD-10, codes.
Clause 4. The method of any proceeding or preceding claim further comprising the step of applying a psychographic analysis on said set of predicted patients.
Clause 5. The method of any proceeding or preceding claim wherein said psychographic analysis segments the set into at least two segments.
Clause 6. The method of any proceeding or preceding claim wherein a different message is delivered for each of said at least two segments.
Clause 7. The method of any proceeding or preceding claim further comprising the step of matching each of said at least two segments with an individualized care strategy.
Clause 8. The method of any proceeding or preceding claim wherein said psychographic analysis comprise using a cluster analysis.
Clause 9. The method of any proceeding or preceding claim wherein said adverse healthcare event comprises admission into inpatient acute care hospitals.
Clause 10. The method of any proceeding or preceding claim wherein said adverse healthcare event comprises admission into post acute care hospitals and services.
Clause 11. The method of any proceeding or preceding claim wherein said adverse healthcare event comprises a PQI-qualifying visit.
Clause 12. The method of any proceeding or preceding claim wherein said predictive model predicts the type of PQI-qualifying visit.
Clause 13. The method of any proceeding or preceding claim wherein said processing and receiving step comprises processing and receiving data from at least two separate sources.
Clause 14. The method of any proceeding or preceding claim wherein said data is aggregated onto a server.
Clause 15. The method of any proceeding or preceding claim wherein said at least one source comprises insurance data.
Clause 16. The method of any proceeding or preceding claim wherein said at least one source comprises EMR data.
Clause 17. The method of any proceeding or preceding claim wherein said predictive model relies upon at least 10 features.
Clause 18. The method of any proceeding or preceding claim wherein said predictive model comprises an area under the curve of greater than 70%.
Clause 19. A system for reducing adverse healthcare events for an ailment, said system comprising:
   a server to receive data from at least one source;
   a predictive model coupled to said server, wherein said predictive model obtains a set of predicted patients, wherein the set of predicted patients are predicted to experience an adverse healthcare event for said ailment within a specified time frame.
Clause 20. The system of any proceeding or preceding claim wherein said system further comprises a delivery mechanism to deliver a message to a patient, wherein the message relates to preventing future adverse healthcare events for said ailment, and wherein said message is based on the assignment of that patient to a psychographic segment.
Clause 21. The system of any proceeding or preceding claim further comprising the step of applying a psychographic analysis on said set of predicted patients.
Clause 22. The system of any proceeding or preceding claim wherein said psychographic analysis segments the set into at least two segments.
Clause 23. The system of any proceeding or preceding claim wherein a different message is delivered for each of said at least two segments.
Clause 24. The system of any proceeding or preceding claim further comprising the step of matching each of said at least two segments with an individualized care strategy.
Clause 25. The system of any proceeding or preceding claim wherein said psychographic analysis comprise using a cluster analysis.

1. A method of reducing adverse healthcare events for an ailment, said method comprising the steps of:
processing and receiving data from at least one source;
feeding said data to a predictive model to obtain a set of predicted patients, wherein the set of predicted patients are predicted to experience an adverse healthcare event for said ailment within a specified time frame;
applying a psychographic analysis on at least a portion of said set of predicted patients, wherein said psychographic analysis segments the portion of said set of predicted patients into at least two segments of patients which share personality characteristics;
matching said segments with patient care approaches likely to be effective and cost efficient;
delivering a message to said predicted patients, wherein the message relates to preventing future adverse healthcare events for said ailment; and wherein said adverse healthcare event comprises admission into inpatient acute care hospitals.

2. The method of claim 1 further comprising applying clinical analysis to the data received from said at least one source.

3. The method of claim 2 wherein said clinical analysis step utilizes an algorithm.

4. (canceled)

5. (canceled)

6. The method of claim 1 wherein a different message is delivered for each of said at least two segments.

7. The method of claim 1 wherein said matching comprises matching each of said at least two segments with an individualized care strategy.

8. The method of claim 1 wherein said psychographic analysis comprise using a cluster analysis.

9. (canceled)

10. The method of claim 1 wherein said adverse healthcare event comprises admission into post acute care hospitals and services.

11. The method of claim 1 wherein said adverse healthcare event comprises a Prevention Quality Indicator qualifying visit.

12. The method of claim 1 wherein said predictive model predicts the type of Prevention Quality Indicator qualifying visit.

13. The method of claim 1 wherein said processing and receiving step comprises processing and receiving data from at least two separate sources.

14. The method of claim 13 wherein said data is aggregated onto a server.

15. The method of claim 1 wherein said at least one source comprises insurance data.

16. The method of claim 1 wherein said at least one source comprises electronic media records data.

17. The method of claim 1 wherein said predictive model relies upon at least 10 features.

18. The method of claim 1 wherein said predictive model comprises an area under curve of greater than 70%.

19. A system for reducing adverse healthcare events for an ailment, said system comprising:
a server to receive data from at least one source;
a predictive model coupled to said server, wherein said predictive model obtains a set of predicted patients, wherein the set of predicted patients are predicted to experience an adverse healthcare event for said ailment within a specified time frame
wherein said system utilizes a psychographic analysis on at least a portion of said set of predicted patients, wherein said psychographic analysis segments the portion of said set of predicted patients into at least two segments of patients which share personality characteristics;
wherein said server matches said segments with patient care approaches likely to be effective and cost efficient;
wherein the system delivers a message to said predicted patients, wherein the message relates to preventing future adverse healthcare events for said ailment; and wherein said adverse healthcare event comprises admission into inpatient acute care hospitals.

20. The system of claim 19 wherein said system further comprises a delivery mechanism to deliver a message to a patient, wherein the message relates to preventing future adverse healthcare events for said ailment.
